(19) United States
(12) Patent Application Publication
(10) Pub. No.: US 2015/0053671 A1
(43) Pub. Date: Feb. 26, 2015

(54) MICROWAVE FREQUENCY SETTING DEVICE, MICROWAVE FREQUENCY SETTING METHOD, AND RECORDING MEDIUM

(71) Applicant: ADVANTEST CORPORATION, Tokyo (JP)

(72) Inventor: Hiroyuki KURITA, Saitama (JP)

(21) Appl. No.: 14/445,251

(22) Filed: Jul. 29, 2014

(30) Foreign Application Priority Data
Aug. 20, 2013 (JP) 2013-170370

(51) Int. Cl. H05B 6/70; H05B 6/68; H05B 6/64

(52) U.S. Cl. CPC H05B 6/705; H05B 6/6447; H05B 6/68
USPC 219/709

(57) ABSTRACT

According to a microwave frequency setting device, an additional signal source outputs an additional signal. An adder adds the additional signal to a microwave to output the microwave thus-obtained. A reflected signal measurement section measures a power of a reflected signal that is produced by reflection of an output from the adder having entered a microwave furnace, the microwave furnace being adapted to accommodate therein an object to be processed with the microwave. A local minimum frequency measurement section measures a local minimum frequency, the local minimum frequency being a frequency at which a measurement result provided by the reflected signal measurement section has a local minimum. A frequency setting section sets a frequency of the microwave to the local minimum frequency measured by the local minimum frequency measurement section. A frequency band of the additional signal includes a resonance frequency of the microwave furnace.

### BACKGROUND OF THE INVENTION

1. Field of the Invention

The present invention relates to setting of the frequency of microwaves incident on a microwave furnace.

2. Related Art

It is conventionally known that an object to be heated is disposed in a furnace and heated by applying microwaves to the inside of the furnace (refer to Abstract of JP 10-504931 A, for example). To allow microwaves to propagate into the furnace, the frequency of the microwave is preferably matched with a resonance frequency of the furnace. A large difference between the frequency of the microwave and the resonance frequency of the furnace causes the microwaves to be reflected without propagating into the furnace.

### SUMMARY OF THE INVENTION

However, when the microwaves are applied to the inside of the furnace while matching the frequency of the microwaves with the resonance frequency of the furnace, the temperature of an object in the furnace changes due to heating. This might also change a dielectric constant of the object, leading to a change in resonance frequency of the furnace. As a result, the frequency of the microwaves does not match with the changed resonance frequency of the furnace, which causes some of the microwaves to be reflected without propagating into the furnace.

Therefore, it is an object of the present invention to set the frequency of a microwave according to a change in resonance frequency of a microwave furnace, thereby decreasing a difference in frequency therebetween.

According to the present invention, a microwave frequency setting device, includes: an additional signal source that outputs an additional signal; an adder that adds the additional signal to a microwave to output the microwave thus-obtained; a reflected signal measurement section that measures a power of a reflected signal that is produced by reflection of an output from the adder having entered a microwave furnace, the microwave furnace being adapted to accommodate therein an object to be processed with the microwave; a local minimum frequency measurement section that measures a local minimum frequency, the local minimum frequency being a frequency at which a measurement result provided by the reflected signal measurement section has a local minimum; and a frequency setting section that sets a frequency of the microwave to the local minimum frequency measured by the local minimum frequency measurement section, wherein a frequency band of the additional signal includes a resonance frequency of the microwave furnace.

According to the thus constructed microwave frequency setting device, an additional signal source outputs an additional signal. An adder adds the additional signal to a microwave to output the microwave thus-obtained. A reflected signal measurement section measures a power of a reflected signal that is produced by reflection of an output from the adder having entered a microwave furnace, the microwave furnace being adapted to accommodate therein an object to be processed with the microwave. A local minimum frequency measurement section measures a local minimum frequency, the local minimum frequency being a frequency at which a measurement result provided by the reflected signal measurement section has a local minimum. A frequency setting section sets a frequency of the microwave to the local minimum frequency measured by the local minimum frequency measurement section. A frequency band of the additional signal includes a resonance frequency of the microwave furnace.

According to the microwave frequency setting device of the present invention, a power of the additional signal may be so weak as not to interrupt the process on the object with the microwave.

According to the microwave frequency setting device of the present invention, a frequency of the additional signal may change depending on time.

According to the microwave frequency setting device of the present invention, the additional signal may be a pulse signal.

According to the present invention, a method of setting a microwave frequency includes: an additional signal step that outputs an additional signal; an adding step that adds the additional signal to a microwave to output the microwave thus-obtained; a reflected signal measurement step that measures a power of a reflected signal that is produced by reflection of an output from the adding step having entered a microwave furnace, the microwave furnace being adapted to accommodate therein an object to be processed with the microwave; a local minimum frequency measurement step that measures a local minimum frequency, the local minimum frequency being a frequency at which a measurement result provided by the reflected signal measurement step has a local minimum; and a frequency setting step that sets a frequency of the microwave to the local minimum frequency measured by the local minimum frequency measurement step, wherein a frequency band of the additional signal includes a resonance frequency of the microwave furnace.

The present invention is a computer-readable medium having a program of instructions for execution by a computer to perform a microwave frequency setting process of a microwave frequency setting device including: an additional signal source that outputs an additional signal; an adder that adds the additional signal to a microwave to output the microwave thus-obtained; and a reflected signal measurement section that measures a power of a reflected signal that is produced by reflection of an output from the adder having entered a microwave furnace, the microwave furnace being adapted to accommodate therein an object to be processed with the microwave; the microwave frequency setting process including: a local minimum frequency measurement step that measures a local minimum frequency, the local minimum frequency being a frequency at which a measurement result provided by the reflected signal measurement section has a local minimum; and a frequency setting step that sets a frequency of the microwave to the local minimum frequency measured by the local minimum frequency measurement step, wherein a frequency band of the additional signal includes a resonance frequency of the microwave furnace.

### BRIEF DESCRIPTION OF THE DRAWINGS

FIG. 1 shows a functional block diagram of the configuration of a microwave frequency setting device according to an embodiment of the present invention;

FIG. 2(a) is a graph showing the power Pr of the reflected waves on the assumption that after a resonance frequency of the microwave furnace 2 is changed, only the microwaves are applied to the microwave furnace 2, and

FIG. 2(b) is a graph of the power Pr of the reflected waves on the assumption that only an additional signal is applied to the microwave furnace 2; and

FIG. 3 is a graph showing a power Pr of a reflected wave in the case where the microwave to which an additional signal is added enters the microwave furnace 2 after the resonance frequency of the microwave furnace 2 is changed.

### DESCRIPTION OF THE PREFERRED EMBODIMENTS

In the following, preferred embodiments of the present invention will be described with reference to the accompanying drawings.

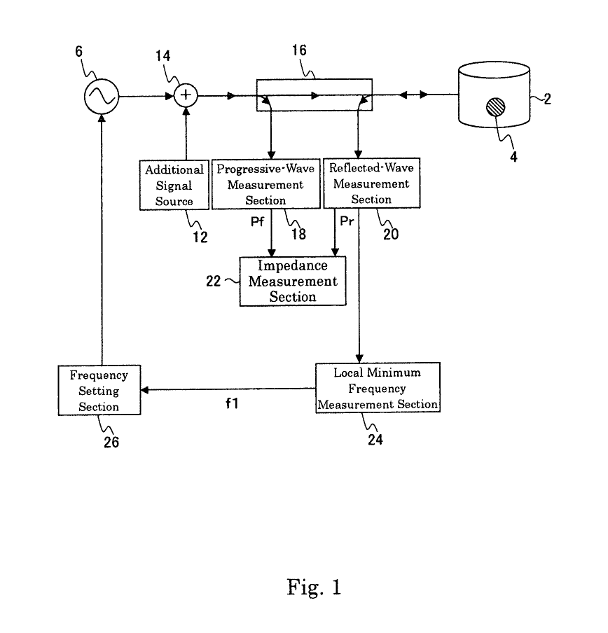

FIG. 1 shows a functional block diagram of the configuration of a microwave frequency setting device according to an embodiment of the present invention.

A microwave furnace 2 accommodates therein an object 4. The object 4 is to be subjected to a process with microwaves (for example, heating or chemical reaction). A microwave signal source 6 outputs microwaves toward the microwave furnace 2. The frequency of the microwave output from the microwave signal source 6 is set to a (or an initial) resonance frequency f0 of the microwave furnace 2, so that the microwave can effectively enter the inside of the microwave furnace 2 (with little reflection of the microwaves by the microwave furnace 2). However, the object 4 subjected to the process with the microwaves might change the dielectric constant of the object 4, thereby changing the resonance frequency of the microwave furnace 2 from f0 to f1. A Q value of the microwave furnace 2 to which an output from the microwave signal source 6 is input is generally high.

The microwave frequency setting device includes an additional signal source 12, an adder 14, a directional coupler 16, a progressive-wave measurement section 18, a reflected-wave measurement section (reflected signal measurement section) 20, an impedance measurement section 22, a local minimum frequency measurement section 24, and a frequency setting section 26.

The additional signal source 12 outputs an additional signal. The frequency of the additional signal changes depending on the time. For example, the additional signal is a frequency sweep signal. A frequency band of the additional signal includes the resonance frequency f1 of the microwave furnace 2 (after the change). The frequency band of the additional signal may include the (initial) resonance frequency f0 of the microwave furnace 2. In use of the frequency sweep signal as the additional signal, the frequency band of the additional signal means a range where the frequency of the additional signal changes.

The adder 14 adds the additional signal to the microwave, and output the resultant microwave. The power of the additional signal is so weak as not to interrupt the process with the microwaves on the object 4 even after the addition of the additional signal to the microwave. For example, the power of the additional signal is considered to be approximately one thousandth of the power of the microwave. The power of the additional signal is to be set substantially constant without depending on the frequency.

The directional coupler 16 guides the output from the adder 14 to the microwave furnace 2 and the progressive-wave measurement section 18. The output from the adder 14 is incident on the microwave furnace 2 to produce a reflected signal. The reflected signal is guided by the directional coupler 16 to the reflected signal measurement section (reflected signal measurement section) 20.

The progressive-wave measurement section 18 receives the output from the adder 14 (corresponding to a progressive wave) via the directional coupler 16, and measures a power Pf of the progressive wave.

The output from the adder 14 enters the microwave furnace 2 via the directional coupler 16 to produce a reflected signal. A power Pr of the reflected signal (reflected wave) is measured by the reflected-wave measurement section (reflected signal measurement section) 20.

The impedance measurement section 22 receives the power Pf of the progressive wave and the power Pr of the reflected wave, and outputs a ratio between both powers as an impedance of the microwave furnace 2. The measurement of the impedance of the microwave furnace 2 can estimate the state of the object 4.

The local minimum frequency measurement section 24 measures a local minimum frequency, which is a frequency at which the measurement result provided by the reflected signal measurement section 20 has a local minimum. The local minimum frequency matches with the resonance frequency f1 of the microwave furnace 2 (after the change).

The frequency setting section 26 sets the frequency of the microwave output from the microwave signal source 6 to the local minimum frequency f1 measured by the local minimum frequency measurement section 24.

The operation of the embodiment of the present invention will be described below.

The resonance frequency of the microwave furnace 2 is f0 in the initial state. The frequency of the microwave output from the microwave signal source 6 is set to f0, so that the microwaves efficiently enter the microwave furnace 2 with little reflection thereof. The process on the object 4 with the microwaves changes the dielectric constant of the object 4, thereby changing the resonance frequency of the microwave furnace 2 from f0 to f1.

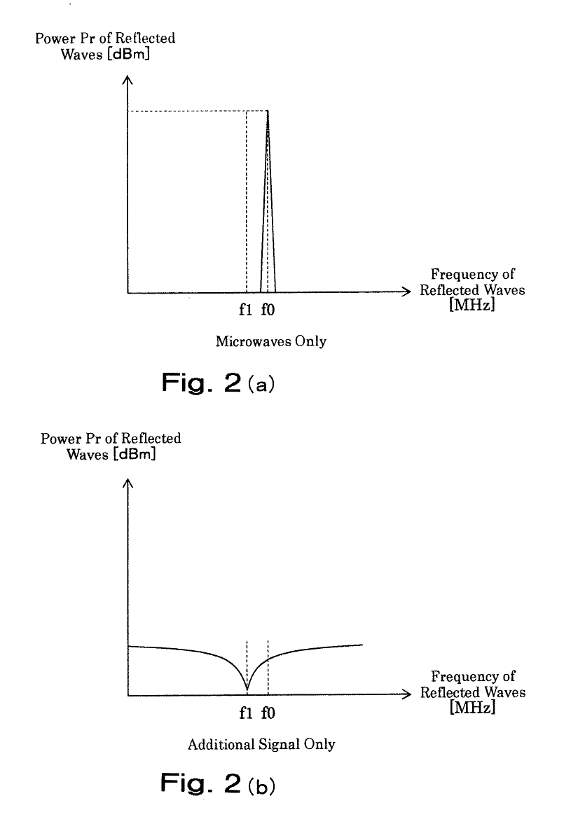

FIG. 2(a) is a graph showing the power Pr of the reflected waves on the assumption that after a resonance frequency of the microwave furnace 2 is changed, only the microwaves are applied to the microwave furnace 2. FIG. 2(b) is a graph of the power Pr of the reflected waves on the assumption that only an additional signal is applied to the microwave furnace 2.

Referring to FIG. 2(a), when the resonance frequency of the microwave furnace 2 changes from f0 to f1, most of the microwaves do not propagate into the microwave furnace 2 and are reflected because of a high Q value of the microwave furnace 2. At the frequency f0, the power Pr of the reflected waves becomes high.

Referring to FIG. 2(b), a frequency band of the additional signal (a range where the frequency of the additional signal changes) is wide. The power of the additional signal is substantially constant regardless of the frequency of the signal. Thus, at the resonance frequency f1 of the microwave furnace 2 (after the change), most of the additional signals propagate into the microwave furnace 2, and therefore, the power Pr of the reflected wave is reduced to the local minimum value. On the other hand, at a frequency far from the resonance frequency f1 of the microwave furnace 2 (after the change), most of the additional signals are reflected from the microwave furnace 2, resulting in the high power Pr of the reflected wave.

In fact, the adder 14 adds the additional signal output from the additional signal source 12 to the microwave output from the microwave signal source 6, so that the resultant enters the microwave furnace 2 via the directional coupler 16.

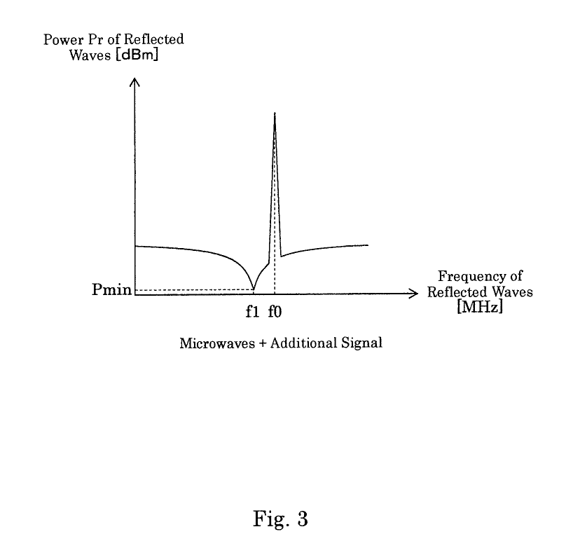

FIG. 3 is a graph showing a power Pr of a reflected wave in the case where the microwave to which an additional signal is added enters the microwave furnace 2 after the resonance frequency of the microwave furnace 2 is changed.

In the case where the microwave to which an additional signal is added enters the microwave furnace 2 after the resonance frequency of the microwave furnace 2 is changed, the graph of the power Pr of the reflected wave substantially matches with a graph obtained by adding the graph of FIG. 2(b) to the graph of FIG. 2(a), resulting in the local minimum value Pmin at the frequency f1.

Here, the reflected wave measurement section 20 measures the power Pr of the reflected wave in the case where the microwave to which the additional signal is added enters the microwave furnace 2 via the directional coupler 16 (see FIG. 3). The measurement result of the power Pr of the reflected wave is sent to the local minimum frequency measurement section 24.

The local minimum frequency measurement section 24 measures a local minimum frequency, which is a frequency at which the measurement result of the power Pr of the reflected wave has a local minimum. The local minimum frequency matches with the resonance frequency f1 of the microwave furnace 2 (after the change). The local minimum frequency f1 is set by the frequency setting section 26.

The frequency setting section 26 sets the frequency of the microwaves output from the microwave signal source 6 to the local minimum frequency f1 measured by the local minimum frequency measurement section 24 (that is, the resonance frequency of the microwave furnace 2 (after the change)). With this arrangement, the microwaves can effectively enter the inside of the microwave furnace 2 with little reflection thereof.

At this time, the progressive-wave measurement section 18 measures the power Pf of the progressive wave by receiving the output from the adder 14 (corresponding to the progressive wave) via the directional coupler 16. The output from the adder 14 enters the microwave furnace 2 via the directional coupler 16 to produce a reflected signal. The power Pr of the reflected signal (reflected wave) is measured by the reflected-wave measurement section (reflected signal measurement section) 20. The impedance measurement section 22 receives the power Pf of the progressive wave and the power Pr of the reflected wave, and outputs a ratio between both powers as an impedance of the microwave furnace 2.

This embodiment of the present invention can set the frequency of the microwave to f1 according to a change in resonance frequency of the microwave furnace 2 (from f0 to f1), thereby matching the frequency of the microwave with the resonance frequency of the microwave furnace 2.

Further, the power of the additional signal is so weak that the frequency of the microwave can be set while the object 4 is subjected to the process with the microwaves.

The additional signal has been described above as the sweep signal, but may be an impulse signal. It is actually difficult to generate the impulse signal (whose duration is infinitesimally small and whose height is infinity). Thus, a pulse signal whose duration is short (which needs to include a component of the resonance frequency f1) may be used as the additional signal.

The embodiments described above can be implemented in the following way. A computer equipped with a CPU, a hard disk, and a media (floppy (trademark) disk, CD-ROM, etc.) reader is adapted to read media that store therein programs for achieving the above-mentioned components, for example, the local minimum frequency measurement section 24 and the frequency setting section 26. Then, the media read are installed in the hard disk. Even this method can achieve the above-mentioned functions.

What is claimed is:

1. A microwave frequency setting device, comprising:
an additional signal source that outputs an additional signal;
an adder that adds the additional signal to a microwave to output the microwave thus-obtained;
a reflected signal measurement section that measures a power of a reflected signal that is produced by reflection of an output from the adder having entered a microwave furnace, the microwave furnace being adapted to accommodate therein an object to be processed with the microwave;
a local minimum frequency measurement section that measures a local minimum frequency, the local minimum frequency being a frequency at which a measurement result provided by the reflected signal measurement section has a local minimum; and
a frequency setting section that sets a frequency of the microwave to the local minimum frequency measured by the local minimum frequency measurement section, wherein
a frequency band of the additional signal includes a resonance frequency of the microwave furnace.

2. The microwave frequency setting device according to claim 1, wherein
a power of the additional signal is so weak as not to interrupt the process on the object with the microwave.

3. The microwave frequency setting device according to claim 1, wherein
a frequency of the additional signal changes depending on time.

4. The microwave frequency setting device according to claim 1, wherein
the additional signal is a pulse signal.

5. The microwave frequency setting device according to claim 2, wherein
a frequency of the additional signal changes depending on time.

6. The microwave frequency setting device according to claim 2, wherein
the additional signal is a pulse signal.

7. A method of setting a microwave frequency, comprising:
an additional signal step that outputs an additional signal;
an adding step that adds the additional signal to a microwave to output the microwave thus-obtained;
a reflected signal measurement step that measures a power of a reflected signal that is produced by reflection of an output from the adding step having entered a microwave furnace, the microwave furnace being adapted to accommodate therein an object to be processed with the microwave;
a local minimum frequency measurement step that measures a local minimum frequency, the local minimum frequency being a frequency at which a measurement result provided by the reflected signal measurement step has a local minimum; and
a frequency setting step that sets a frequency of the microwave to the local minimum frequency measured by the local minimum frequency measurement step, wherein
a frequency band of the additional signal includes a resonance frequency of the microwave furnace.

8. A computer-readable medium having a program of instructions for execution by a computer to perform a microwave frequency setting process of a microwave frequency setting device including: an additional signal source that outputs an additional signal; an adder that adds the additional signal to a microwave to output the microwave thus-obtained; and a reflected signal measurement section that measures a power of a reflected signal that is produced by reflection of an output from the adder having entered a microwave furnace, the microwave furnace being adapted to accommodate therein an object to be processed with the microwave; said microwave frequency setting process comprising:
a local minimum frequency measurement step that measures a local minimum frequency, the local minimum frequency being a frequency at which a measurement result provided by the reflected signal measurement section has a local minimum; and
a frequency setting step that sets a frequency of the microwave to the local minimum frequency measured by the local minimum frequency measurement step, wherein
a frequency band of the additional signal includes a resonance frequency of the microwave furnace.
